(19) United States
(12) Patent Application Publication
(10) Pub. No.: US 2026/0186398 A1
(43) Pub. Date: Jul. 2, 2026

(54) TRANSPARENT PROJECTION FILM STRUCTURE

(71) Applicant: INDSUTRIAL TECHNOLOGY RESEARCH INSTITUTE, Hsinchu (TW)

(72) Inventors: Yu- Hsiang LIU, Chiayi City (TW); Chun-Ting Lin, New Taipei City (TW); Hung Tsou, Zhubei City (TW); Yi-Hsiang Huang, Changhua City (TW)

(73) Assignee: INDUSTRIAL TECHNOLOGY RESEARCH INSTITUTE, Hsinchu (TW)

(21) Appl. No.: 19/072,826

(22) Filed: Mar. 6, 2025

(30) Foreign Application Priority Data
Dec. 27, 2024 (TW) 113151050

(51) Int. Cl. G03B 21/60

(52) U.S. Cl. CPC G03B 21/60

(57) ABSTRACT

A transparent projection film structure is provided. The transparent projection film structure includes a substrate layer and multiple light-guiding microstructures disposed on the substrate layer. Each microstructure has at least one inclined surface. The included angle between the inclined surface and the substrate layer defines the first angle. The microstructures are arranged along a direction defined by the first axis and along a direction defined by the second axis. The transparent projection film structure also includes multiple reflective layers disposed on the light-guiding microstructures. The included angle between one side of the orthographic projection of each light-guiding microstructure on the substrate layer and the first axis defines the second angle, which is variable and ranges from −35°0 to +35°.

### CROSS REFERENCE TO RELATED APPLICATIONS

This Application claims priority of Taiwan Patent Application No. 113151050, filed on Dec. 27, 2024, the entirety of which is incorporated by reference herein.

### TECHNICAL FIELD

The present disclosure relates to a transparent projection film structure.

### BACKGROUND

The range of applications for electronic devices equipped with display screens has become increasingly broad and diverse as display technology has developed. Consequently, viewers'demands about the quality of display screens have been steadily increasing.

Transparent display technology may be categorized into transmissive transparent displays and projection-type transparent displays. In a transmissive transparent display, the display panel is made see-through by introducing transparent materials or by creating openings. In a projection-type transparent display, images are projected onto a structure that is projectable and transparent, thereby achieving a transparent display effect.

It is difficult for existing transparent displays to maintain good imaging quality in high-brightness environments (e.g., outdoors). Therefore, there is a need for a transparent projection film structure capable of adapting to high-brightness environments while satisfying the requirements for high transmittance and high image brightness, thereby further enhancing background transmittance and image quality.

### SUMMARY

Some embodiments of the present disclosure provide a transparent projection film structure. The transparent projection film structure includes a substrate layer and multiple light-guiding microstructures disposed on the substrate layer. Each microstructure has at least one inclined surface. The included angle between the inclined surface and the substrate layer defines the first angle. The microstructures are arranged along a direction defined by the first axis and along a direction defined by the second axis. The transparent projection film structure also includes multiple reflective layers disposed on the light-guiding microstructures. The included angle between one side of the orthographic projection of each light-guiding microstructure on the substrate layer and the first axis defines the second angle, which is variable and ranges from −35° to +35°.

### BRIEF DESCRIPTION OF THE DRAWINGS

FIG. 1 is a partial perspective schematic view illustrating the transparent projection film structure according to some embodiments of the present disclosure.

FIG. 2 is a partial top view illustrating the transparent projection film structure according to some embodiments of the present disclosure.

FIG. 3 is a partial cross-sectional view illustrating the transparent projection film structure according to some embodiments of the present disclosure.

FIG. 4 is a partially enlarged (cross-sectional) view illustrating the substrate layer, the light-guiding microstructures, and the reflective layers according to some embodiments of the present disclosure.

FIG. 5 is a partial cross-sectional view illustrating the transparent projection film structure according to some embodiments of the present disclosure.

FIG. 6 is a top view illustrating some light-guiding microstructures according to some embodiments of the present disclosure.

FIG. 7 is a partial cross-sectional view illustrating the transparent projection film structure according to some other embodiments of the present disclosure.

FIG. 8 is a partial perspective schematic view illustrating the transparent projection film structure according to some embodiments of the present disclosure.

FIG. 9 is a partial cross-sectional view illustrating the transparent projection film structure according to some embodiments of the present disclosure.

FIG. 10 is a partial cross-sectional view illustrating the transparent projection film structure according to some other embodiments of the present disclosure.

FIG. 11 is a partial top view illustrating the transparent projection film structure according to some embodiments of the present disclosure.

### DETAILED DESCRIPTION

The following disclosure provides many different embodiments, or examples, for implementing different features of the subject matter provided. Some examples of components and arrangements are described below to simplify the present disclosure. These are, of course, merely examples and are not intended to be limiting. For example, a first feature is formed on a second feature in the description that follows may include embodiments in which the first feature and second feature are formed in direct contact or indirect contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean +/−20% of the stated value, or +/−10% of the stated value, or +/−5% of the stated value, or +/−3% of the stated value, or +/−2% of the stated value, or +/−1% of the stated value, or even +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may use the same or similar reference numerals and/or letters in the following embodiments. This repetition is for the purpose of simplicity and clarity and does not in itself dictate a relationship between the various embodiments and/or configurations discussed.

In the embodiments of the present disclosure, the transparent projection film structure includes a substrate layer and multiple light-guiding microstructures disposed on the substrate layer. Each microstructure has at least one inclined surface, the included angle between the inclined surface and the substrate layer defines a first angle. The microstructures are arranged along a direction defined by a first axis and along a direction defined by a second axis. The transparent projection film structure also includes multiple reflective layers disposed on the light-guiding microstructures. An included angle between one side of the orthographic projection of each light-guiding microstructure on the substrate layer and the first axis defines a second angle, which is variable and ranges from −35° to +35°.

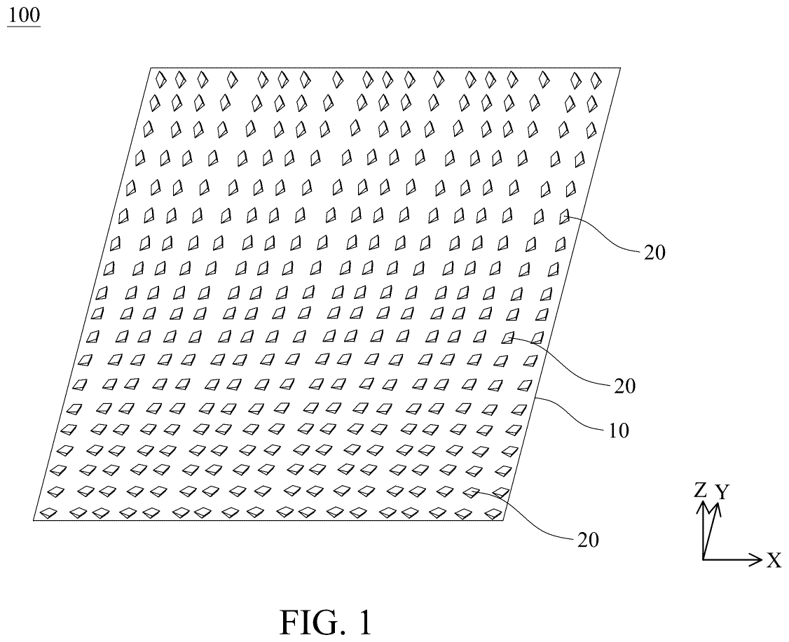

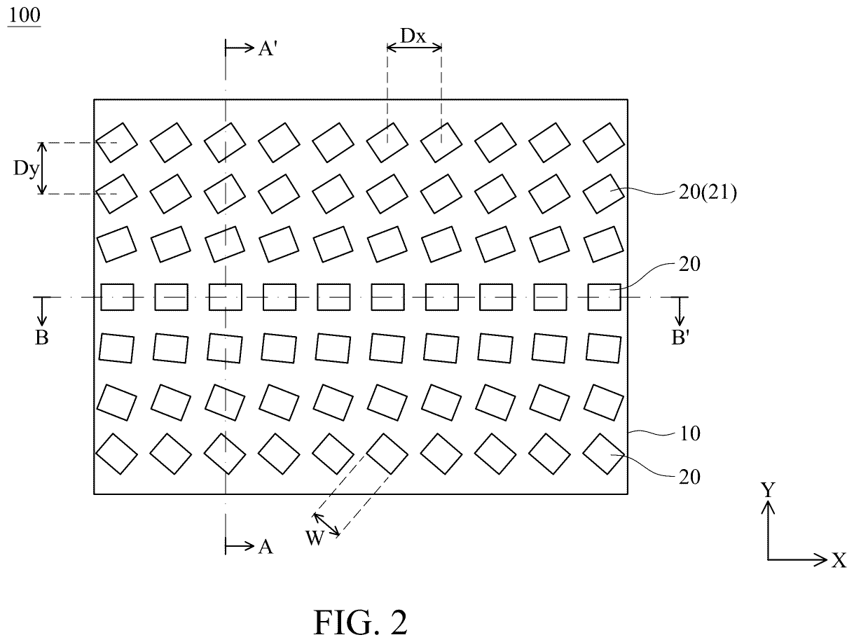

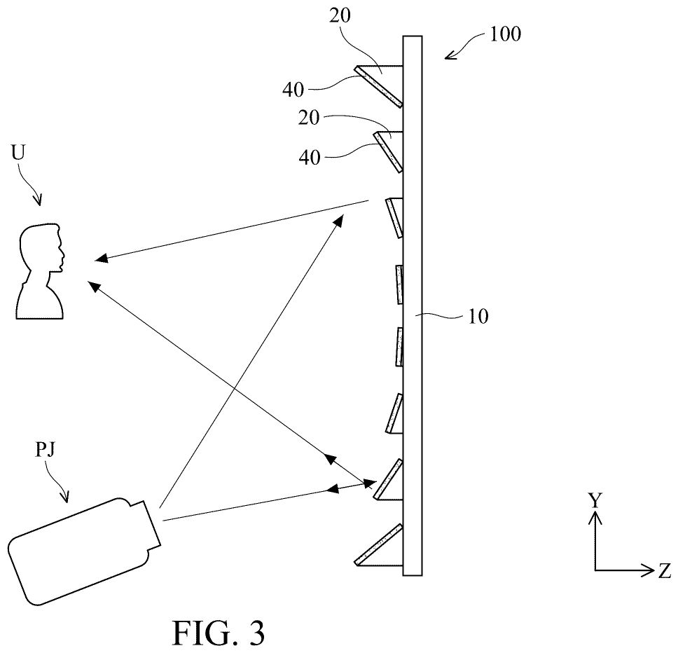

FIG. 1 is a partial perspective schematic view illustrating the transparent projection film structure 100 according to some embodiments of the present disclosure. FIG. 2 is a partial top view illustrating the transparent projection film structure 100 according to some embodiments of the present disclosure. FIG. 3 is a partial cross-sectional view illustrating the transparent projection film structure 100 according to some embodiments of the present disclosure. For example, FIG. 3 may be a cross-sectional view taken along line A-A′ (i.e., along the Y-axis) in FIG. 2, but the present disclosure is not limited thereto. It should be noted that some components of the transparent projection film structure 100 have been omitted in FIG. 1 to FIG. 3 for the sake of brevity.

Referring to FIG. 1 to FIG. 3, in some embodiments, the transparent projection film structure 100 includes a substrate layer 10. For example, the transmittance of the substrate layer 10 may range from about 30% to about 95%, and the haze of the substrate layer 10 may be less than or equal to about 5%. In some embodiments, the substrate layer 10 may include glass, titanium dioxide (TiO₂), polyethylene terephthalate (PET), polyimide (PI), epoxy resin, polyester (e.g., OKP4), poly (methyl methacrylate) (PMMA), any other similar material, or a combination thereof.

Referring to FIG. 1 to FIG. 3, in some embodiments, the transparent projection film structure 100 also includes multiple light-guiding microstructures 20 disposed on the substrate layer 10. For example, the light-guiding microstructures 20 may include organic glass (e.g., PMMA), epoxy resin, silicone resin, polyurethane, polyester (e.g., OKP4), any other suitable material, or a combination thereof, but the present disclosure is not limited thereto. Moreover, the light-guiding microstructures 20 may be formed by a photoresist reflow method, a hot embossing method, a photolithography process, an ultra-precision processing, a UV imprinting, any other appropriate method, or a combination thereof. For example, the step of forming the light-guiding microstructures 20 may include a spin-coating process, a photolithography process, an etching process, any other suitable process, or a combination thereof, but the present disclosure is not limited thereto. Furthermore, the refractive index of the light-guiding microstructures 20 is about 1.5 to about 2, the transmittance of the light-guiding microstructures 20 is greater than or equal to about 80%, and the haze of the light-guiding microstructures 20 is less than or equal to about 15%.

In some embodiments, as shown in the top view of FIG. 2, the light-guiding microstructures 20 are arranged along a direction defined by a first axis (e.g., the X-axis) and along a direction defined by a second axis (e.g., the Y-axis). In this embodiment, the first axis (e.g., the X-axis) is perpendicular to the second axis (e.g., the Y-axis), but the present disclosure is not limited thereto. In some other embodiments, the first axis and the second axis may be two non-parallel axes in any plane. Moreover, as shown in FIG. 1 and FIG. 2, in this embodiment, the light-guiding microstructures 20 are correspondingly arranged along the direction defined by the X-axis and along the direction defined by the Y-axis. In other words, the positions of each light-guiding microstructure 20 correspond to one another.

Additionally, as shown in FIG. 2, in some embodiments, in the direction defined by the first axis (e.g., the X-axis), the distance Dx between two adjacent light-guiding microstructures 20 may range from about 50 micrometers (μm) to about 400 μm (e.g., about 50 μm to about 200 μm). Alternatively, in some embodiments, in the direction defined by the second axis (e.g., the Y-axis), the distance Dy between two adjacent light-guiding microstructures 20 may range from about 50 μm to about 400 μm (e.g., about 50 μm to about 200 μm). In the top view shown in FIG. 2, for example, the width W of the light-guiding microstructure 20 ranges from about 5 μm to about 20 μm. In this embodiment, the orthographic projection of the light-guiding microstructure 20 on the substrate layer 10 may be a rectangle, and the width W of the light-guiding microstructure 20 may be defined as the width of the rectangle's longer side, but the present disclosure is not limited thereto. In some other embodiments, the orthographic projection of the light-guiding microstructure 20 on the substrate layer 10 may be trapezoidal, triangular, conical, or any other suitable shape, which may be adjusted based on actual needs.

Referring to FIG. 3, in some embodiments, the transparent projection film structure 100 includes multiple reflective layers 40 disposed on the light-guiding microstructures 20. In this embodiment, the reflective layer 40 is in direct contact with (the inclined surface of) the corresponding light-guiding microstructure 20, but the present disclosure is not limited thereto. In some other embodiments, additional components (e.g., an adhesive material) may be disposed between the reflective layer 40 and the light-guiding microstructure 20.

In some embodiments, the reflective layer 40 may include a metal. For example, the metal may include gold (Au), nickel (Ni), platinum (Pt), palladium (Pd), iridium (Ir), titanium (Ti), chromium (Cr), tungsten (W), aluminum (Al), copper (Cu), silver (Ag), any other suitable material, an alloy thereof, or a combination thereof, but the present disclosure is not limited thereto. Moreover, the reflective layer 40 may be formed by physical vapor deposition, chemical vapor deposition, atomic layer deposition, evaporation, sputtering, any similar process, or a combination thereof, but the present disclosure is not limited thereto. In some embodiments, the reflective layer 40 may include aluminum, silver, titanium, titanium dioxide, zirconium dioxide, silicon dioxide, zinc oxide, tantalum dioxide, any other similar substance, or a combination thereof.

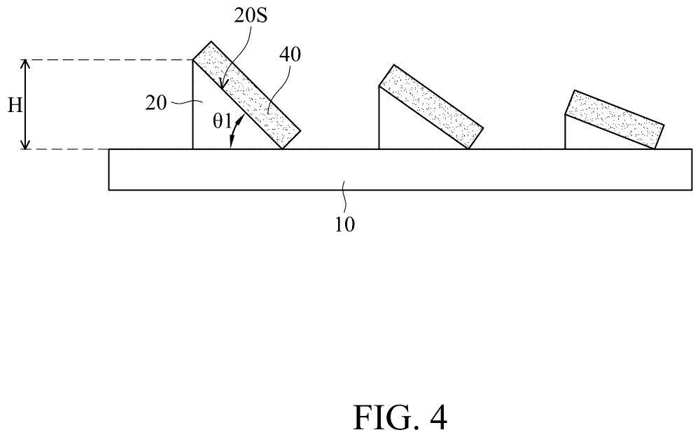

FIG. 4 is a partially enlarged (cross-sectional) view illustrating the substrate layer 10, the light-guiding microstructures 20, and the reflective layers 40 according to some embodiments of the present disclosure. As shown in FIG. 3 and FIG. 4, in some embodiments, each light-guiding microstructure 20 has an inclined surface 20S. In the cross-sectional view shown in, for instance, FIG. 3 and FIG. 4, the included angle between the inclined surface 20S and the substrate layer 10 is defined as a first angle θ1. In some embodiments, the first angle θ1 is variable and ranges from about −50°to about +50°.

In this embodiment, the first angle θ1may be gradually varying. For example, the first angle θ1≈arctan((distance between each light-guiding microstructures and the image center of the transparent projection film structure ±Dx)/(distance between the user and the transparent projection film structure)). As described above, Dx represents the spacing between the light-guiding microstructures 20 along the X-axis direction, which may, for instance, range from about 50 micrometers to about 400 micrometers, but the present disclosure is not limited thereto. As shown in FIG. 3, when the user U and the projector PJ are located on the same side, the user U may be positioned in front of the image center of the transparent projection film structure 100. Taking the user U's line of sight (horizontal view) as reference, the absolute value of the first angle θ1 gradually increases in the +Y direction (e.g., from 0 up to about +50°), and the absolute value of the first angle θ1 gradually increases in the-Y direction (e.g., from 0 up to about −50°), but the present disclosure is not limited thereto. In this embodiment, in the cross-sectional views shown, for example, in FIG. 3 and FIG. 4, each light-guiding microstructure 20 may be a right triangle, and the reflective layer 40 is disposed on the inclined surface 20S of the right triangle, but the present disclosure is not limited thereto. In some other embodiments, the aforementioned right angle may be changed to an obtuse angle, or the light-guiding microstructure 20 may include a rounded corner, and the reflective layer 40 may be disposed on the inclined surface 20S facing the user U. In other words, in some embodiments, each light-guiding microstructure 20 may be any geometric shape that includes at least one inclined surface (i.e., a surface not parallel to the substrate layer 10), and such configurations are also applicable to other suitable embodiments of the present disclosure. Furthermore, as shown in FIG. 4, in some embodiments, the height H of each light-guiding microstructure 20 ranges from about 5 micrometers (μm) to about 10 micrometers.

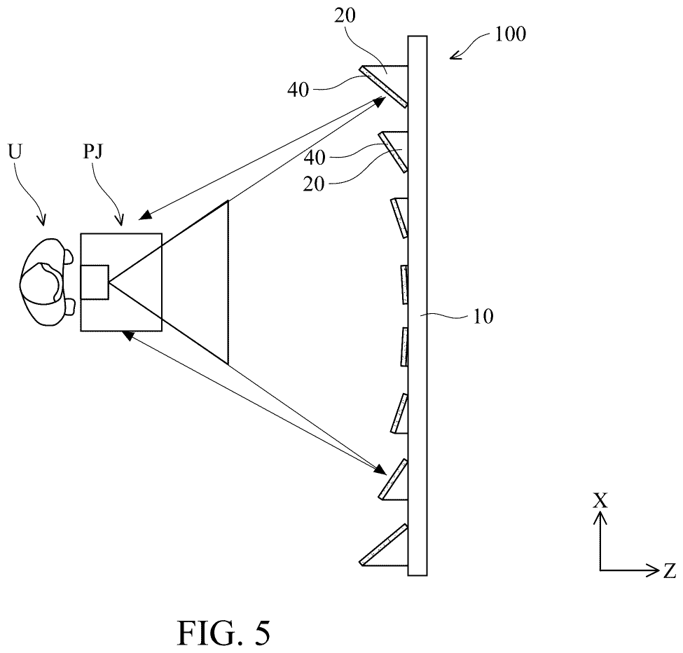

FIG. 5 is a partial cross-sectional view illustrating the transparent projection film structure 100 according to some embodiments of the present disclosure. For example, FIG. 5 may be a cross-sectional view taken along line B-B′ (i.e., along the X-axis) in FIG. 2, but the present disclosure is not limited thereto. As shown in FIG. 5, In this embodiment, the first angle θ1 is gradually varying. For example, when the user U and the projector PJ are located on the same side, the user U may be positioned in front of the image center of the transparent projection film structure 100. Taking the user U's line of sight (horizontal view) as reference, the absolute value of the first angle θ1 gradually increases in the +X direction (e.g., from 0 up to about +50°), and the absolute value of the first angle θ1 gradually increases in the-X direction (e.g., from 0 up to about −50°), but the present disclosure is not limited thereto.

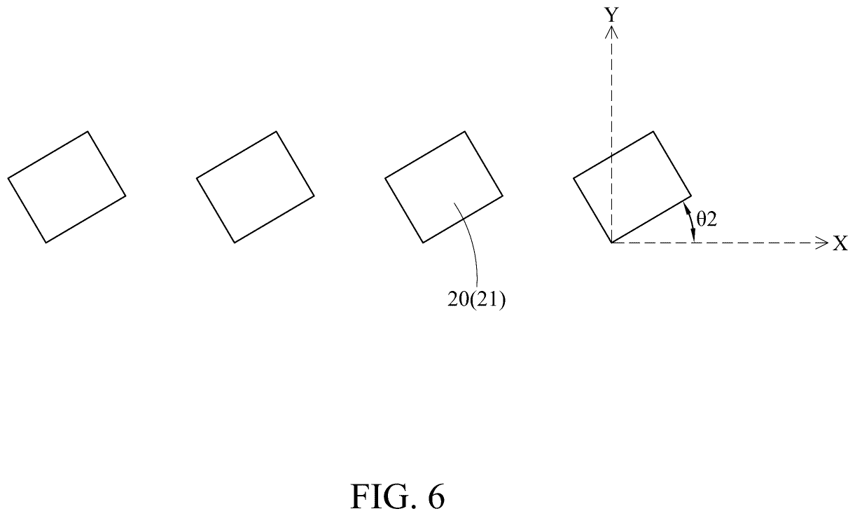

FIG. 6 is a top view illustrating some light-guiding microstructures 20 according to some embodiments of the present disclosure. For example, FIG. 6 shows a top view of the light-guiding microstructures 20 in the same row as the light-guiding microstructure 21 in FIG. 2, but the present disclosure is not limited thereto. Referring to FIG. 2 and FIG. 6, in some embodiments, the included angle between one side of the orthographic projection of each light-guiding microstructure 20(21) on the substrate layer 10 and the X-axis is defined as a second angle θ2, which is variable and ranges from about −35° to about +35°. Alternatively, the included angle between one side of the orthographic projection of each light-guiding microstructure 20(21) on the substrate layer 10 and the Y-axis is defined as a second angle θ2, which is variable and ranges from about −35°to about +35°.

In the embodiment shown in FIG. 2, the second angle θ2 is gradually varying. For example, the second angle θ2≈arctan((distance between each light-guiding microstructures and the image center of the transparent projection film structure±Dy)/(distance between the user and the transparent projection film structure)). As mentioned above, Dy represents the spacing between the light-guiding microstructures 20 along the Y-axis direction, which may, for instance, range from about 50 micrometers to about 400 micrometers, but the present disclosure is not limited thereto. In other words, if the second angle θ2 of the light-guiding microstructure 20 through which line B-B′ passes is taken to be zero, then the absolute value of the second angle θ2 gradually increases in the +Y direction (e.g., from 0 to about +35°) and the absolute value of the second angle θ2 also gradually increases in the-Y direction (e.g., from 0 to about −35°), but the present disclosure is not limited thereto.

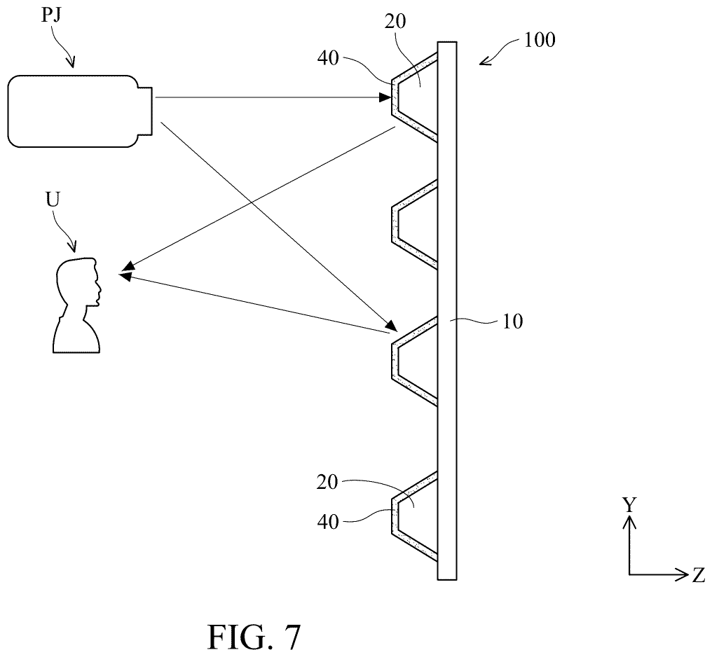

FIG. 7 is a partial cross-sectional view illustrating the transparent projection film structure 100 according to some other embodiments of the present disclosure. For example, FIG. 7 may be a cross-sectional view taken along line A-A′ (i.e., along the Y-axis) in FIG. 2, but the present disclosure is not limited thereto. Referring to FIG. 7, in this embodiment, each light-guiding microstructure 20 may, for example, be trapezoid-like in shape, and the reflective layer 40 is disposed on the top surface and two inclined surfaces of the trapezoid-like shape. It should be noted that FIG. 7 does not depict any changes in the included angle between the inclined surfaces of the trapezoid-like shape and the substrate layer (i.e., the first angle θ1), which does not imply that these included angles are fixed.

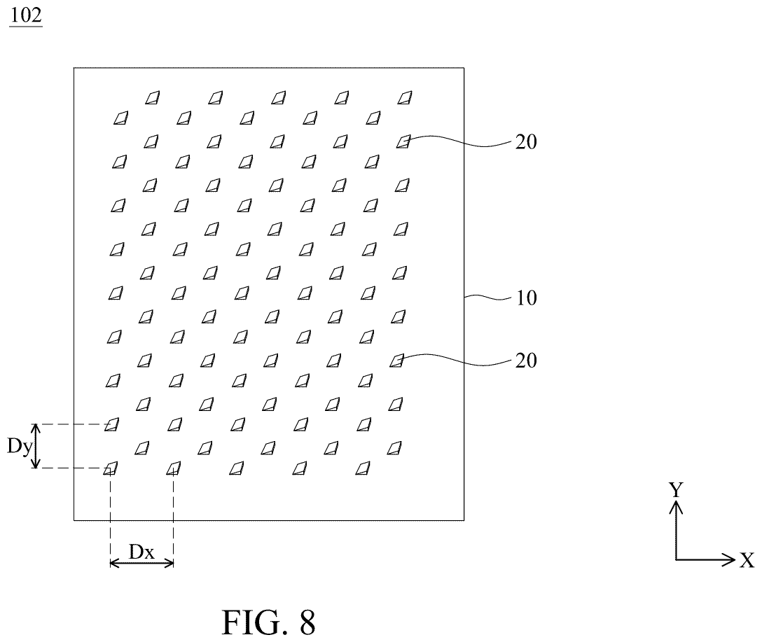

FIG. 8 is a partial perspective schematic view illustrating the transparent projection film structure 102 according to some embodiments of the present disclosure. Similarly, some components of the transparent projection film structure 102 have been omitted in FIG. 8 for the sake of brevity. As shown in FIG. 8, in some embodiments, the light-guiding microstructures 20 are alternately arranged along the direction defined by the X-axis and along the direction defined by the Y-axis. Similarly, in this embodiment, the distance Dx between two adjacent light-guiding microstructures 20 in the direction defined by the X-axis ranges from about 50 micrometers (μm) to about 200 micrometers, or the distance Dy between two adjacent light-guiding microstructures 20 in the direction defined by the Y-axis ranges from about 50 micrometers to about 200 micrometers, but the present disclosure is not limited thereto.

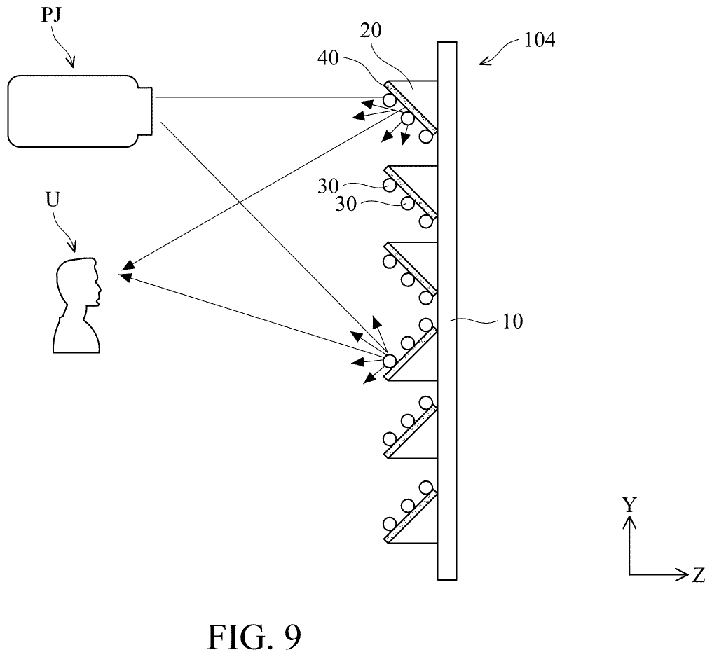

FIG. 9 is a partial cross-sectional view illustrating the transparent projection film structure 104 according to some embodiments of the present disclosure. For example, FIG. 9 may be a cross-sectional view taken along line A-A′ (i.e., along the Y-axis) in FIG. 2, but the present disclosure is not limited thereto. Similarly, some components of the transparent projection film structure 104 have been omitted in FIG. 9 for the sake of brevity. In this embodiment, the transparent projection film structure 104 further includes multiple scattering particles

that may be disposed on the reflective layer 40. For example, the scattering particles 30 may include the same or similar materials as the light-guiding microstructures 20, but the present disclosure is not limited thereto. Alternatively, a surface treatment (e.g., a surface roughening process) may be performed on the light-guiding microstructures 20 to form scattering surfaces. In other words, the scattering particles 30 may be part of the light-guiding microstructures 20 themselves, but the present disclosure is not limited thereto.

In the cross-sectional view of this embodiment, each light-guiding microstructure 20 is a right triangle, and the reflective layer 40 and the scattering particles 30 are disposed on the inclined surface of the right triangle. It should be noted that FIG. 9 does not depict any changes in the included angle between the inclined surface of the right triangle and the substrate layer (i.e., the first angle θ1), which does not imply that these angles are fixed.

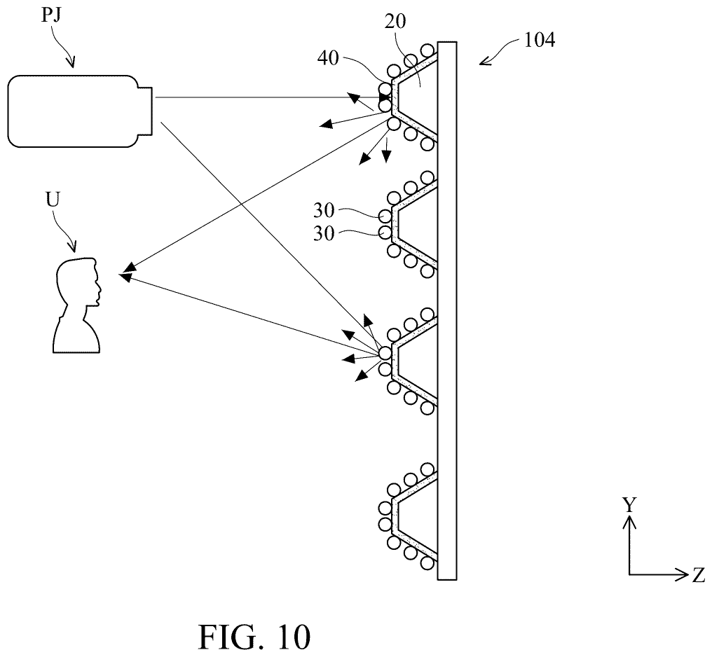

FIG. 10 is a partial cross-sectional view illustrating the transparent projection film structure 104 according to some other embodiments of the present disclosure. In the cross-sectional view of the present embodiment, the light-guiding microstructures 20 may, for example, be trapezoid-like in shape, and the reflective layer 40 and the scattering particles 30 are disposed on the top surface and the two inclined surfaces of the trapezoid-like shape. It should be noted that FIG. 10 does not depict any changes in the included angle between the inclined surfaces of the trapezoid-like shape and the substrate layer (i.e., the first angle θ1), which does not imply these such angles are fixed.

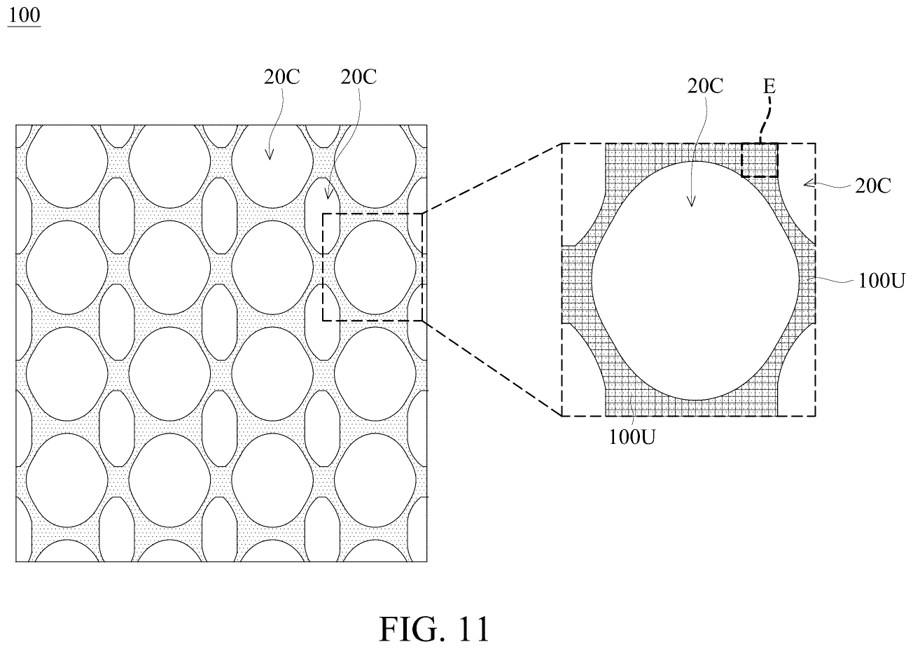

FIG. 11 is a partial top view illustrating the transparent projection film structure 100 according to some embodiments of the present disclosure. For example, FIG. 1 or FIG. 2 may be an enlarged view of region E in FIG. 11, but the present disclosure is not limited thereto. As shown in FIG. 11, multiple hollow regions 20C may be formed between the light-guiding microstructures 20, and each hollow region 20C, for instance, may be formed in a generally circular or elliptical shape. Each hollow region 20C may be configured with a suitable pattern, size, and distribution area according to requirements. In some embodiments, the transparent projection film structure 100 may be divided into multiple 10×10 μm anti-glare structure units 100U, and then the light-guiding microstructures 20 are formed on each anti-glare structure unit 100U, but the present disclosure is not limited thereto.

As noted above,, the transparent projection film structure according to the embodiments of the present disclosure includes multiple light-guiding microstructures that have specific arrangements and/or various angles (i.e., the first angle θ1 and/or the second angle θ2), which may maintain good imaging quality under high-brightness environments, thereby widely applying transparent projection technology to a variety of scenarios, and then integrating interactive systems to achieve excellent transparent display and interactive effects.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims and their equivalents. In addition, although some embodiments of the present disclosure are disclosed above, they are not intended to limit the scope of the present disclosure.

What is claimed is:

1. A transparent projection film structure, comprising:
a substrate layer;
a plurality of light-guiding microstructures disposed on the substrate layer, wherein each of the light-guiding microstructures has at least one inclined surface, an included angle between the inclined surface and the substrate layer defines a first angle, and the light-guiding microstructures are arranged along a direction defined by a first axis and along a direction defined by a second axis; and
a plurality of reflective layers disposed on the light-guiding microstructures,
wherein an included angle between one side of an orthographic projection of each of the light-guiding microstructures on the substrate layer and the first axis defines a second angle, and the second angle is variable and ranges from −35°to +35°.

2. The transparent projection film structure as claimed in claim 1, wherein the second angle is gradually varying.

3. The transparent projection film structure as claimed in claim 2, wherein the second angle is equal to arctan((distance between each of the light-guiding microstructures and an image center of the transparent projection film structure±Dy)/(distance between a user and the transparent projection film structure)), where Dy is a distance between adjacent two of the light-guiding microstructures in the direction defined by the second axis.

4. The transparent projection film structure as claimed in claim 3, wherein Dy ranges from 50 micrometers to 400 micrometers.

5. The transparent projection film structure as claimed in claim 1, wherein the first angle is variable and ranges from −50°to +50°.

6. The transparent projection film structure as claimed in claim 5, wherein the first angle is gradually varying.

7. The transparent projection film structure as claimed in claim 6, wherein the first angle is equal to arctan((distance between each of the light-guiding microstructures and an image center of the transparent projection film structure±Dx)/(distance between a user and the transparent projection film structure)), where Dx is a distance between adjacent two of the light-guiding microstructures in the direction defined by the first axis.

8. The transparent projection film structure as claimed in claim 7, wherein Dx ranges from 50 micrometers to 400 micrometers.

9. The transparent projection film structure as claimed in claim 1, wherein the light-guiding microstructures are correspondingly arranged along the direction defined by the first axis and along the direction defined by the second axis.

10. The transparent projection film structure as claimed in claim 1, wherein the light-guiding microstructures are alternately arranged along the direction defined by the first axis and along the direction defined by the second axis.

11. The transparent projection film structure as claimed in claim 1, wherein in a cross-sectional view, each of the light-guiding microstructures is a geometric shape that comprises at least one inclined surface.

12. The transparent projection film structure as claimed in claim 11, wherein each of the reflective layers is disposed on the at least one inclined surface.

13. The transparent projection film structure as claimed in claim 1, wherein each of the light-guiding microstructures has a scattering surface, or the transparent projection film structure further comprises a plurality of scattering particles disposed on the reflective layers.

14. The transparent projection film structure as claimed in claim 1, wherein each of the light-guiding microstructures has a height ranging from 5 micrometers to 10 micrometers.

15. The transparent projection film structure as claimed in claim 1, wherein each of the light-guiding microstructures has a width ranging from 5 micrometers to 20 micrometers.

16. The transparent projection film structure as claimed in claim 1, wherein each of the light-guiding microstructures comprises organic glass, epoxy resin, silicone resin, polyurethane, polyester, or a combination thereof.

17. The transparent projection film structure as claimed in claim 1, wherein the reflective layers comprise gold, nickel, platinum, palladium, iridium, chromium, tungsten, copper, aluminum, silver, titanium, an alloy thereof, titanium dioxide, zirconium dioxide, silicon dioxide, zinc oxide, tantalum dioxide, or a combination thereof.
